(19) United States
(12) Patent Application Publication
(10) Pub. No.: US 2007/0300144 A1
(43) Pub. Date: Dec. 27, 2007

(54) A METHOD, APPARATUS, AND COMPUTER PROGRAM PRODUCT FOR DISPLAYING DATA IN A SPREADSHEET FORMAT

(76) Inventors: INDRAN NAICK, Cedar Park, TX (US); Jeffrey Wilson, Austin, TX (US)

Correspondence Address: IBM CORP (YA);C/O YEE & ASSOCIATES PC, P.O. BOX 802333, DALLAS, TX, 75380, US

(21) Appl. No.: 11/425,425

(22) Filed: Jun. 21, 2006

(51) Int. Cl. G06F 17/00

(52) U.S. Cl. 715/503

(57) ABSTRACT

A method, apparatus and computer program product for creating and displaying derivative data created from a spreadsheet or table. Templates are used to dynamically create and display the derivative data while viewing the originating spreadsheet.

### BACKGROUND

1. Technical Field of the Present Invention

The present invention generally relates to spreadsheets and, more specifically, to methods, apparatuses, and computer program products that display data in a spreadsheet format.

2. Description of Related Art

The collection and manipulation of information has become an integral part of the life of every individual. This information is, typically, organized and displayed using spreadsheets or similar type software such as Microsoft Excel™ by Microsoft Corporation or Lotus 1-2-3™ by IBM.

The use of these spreadsheets by various individuals and departments within an organization often results in a master type spreadsheet being generated that contains the initial information. This initial information is then used by the individuals and departments to create derivative information using formulas and the like that are according to their desires.

Unfortunately, the generation of these new spreadsheets often require the user not only to derive the formula to generate the desired information but also to copy or reference labels and data from the master spreadsheet. A user will generate the new spreadsheet by constantly switching their view from the master spreadsheet to the new spreadsheet to reference or copy the correct information. This process is inefficient and inconvenient. The nature of this problem is exacerbated whenever the order of the columns or rows is altered so that the formula in the created spreadsheet is no longer accurate.

It would, therefore, be a distinct advantage to have a method, apparatus, and computer program product that would allow a user to employ the information on the master spreadsheet without generating a new spreadsheet. It would be further advantageous if the derived information could be generated and displayed dynamically as the user selects cells that are referenced in a formula.

### SUMMARY OF THE PRESENT INVENTION

In one aspect, the present invention is a method of displaying derivative data in a spreadsheet application. The method includes the steps of creating a spreadsheet application having multiple cells each capable of storing data, and creating a template that retrieves data from one or more of the multiple cells. The method also includes the step of simultaneously displaying the data from template and the multiple cells.

### BRIEF DESCRIPTION OF THE DRAWINGS

The present invention will be better understood and its advantages will become more apparent to those skilled in the art by reference to the following drawings, in conjunction with the accompanying specification, in which:

FIG. 1 is a block diagram illustrating a computer system that implements a preferred embodiment of the present invention;

FIG. 2 is a diagram illustrating an example of a spreadsheet application program for attendance data for various classes rendered in a window;

FIG. 3 is a diagram illustrating an example of a spreadsheet application program for each quarter of the attendance data of FIG. 2;

FIG. 4 is a block diagram illustrating a template data structure according to the teachings of the present invention;

FIG. 5 is a diagram illustrating the spreadsheet application program of FIG. 2 using an example of the template of FIG. 4 according to the teachings of a preferred embodiment of the present invention;

FIG. 6 is a diagram illustrating the spreadsheet application program of FIG. 2 using multiple examples of the template of FIG. 4 according to the teachings of a preferred embodiment of the present invention;

FIG. 7 is a diagram illustrating the spreadsheet application program of FIG. 2 using an example of the template of FIG. 4 according to the teachings of a preferred embodiment of the present invention;

### DETAILED DESCRIPTION OF THE PREFERRED EMBODIMENT OF THE PRESENT INVENTION

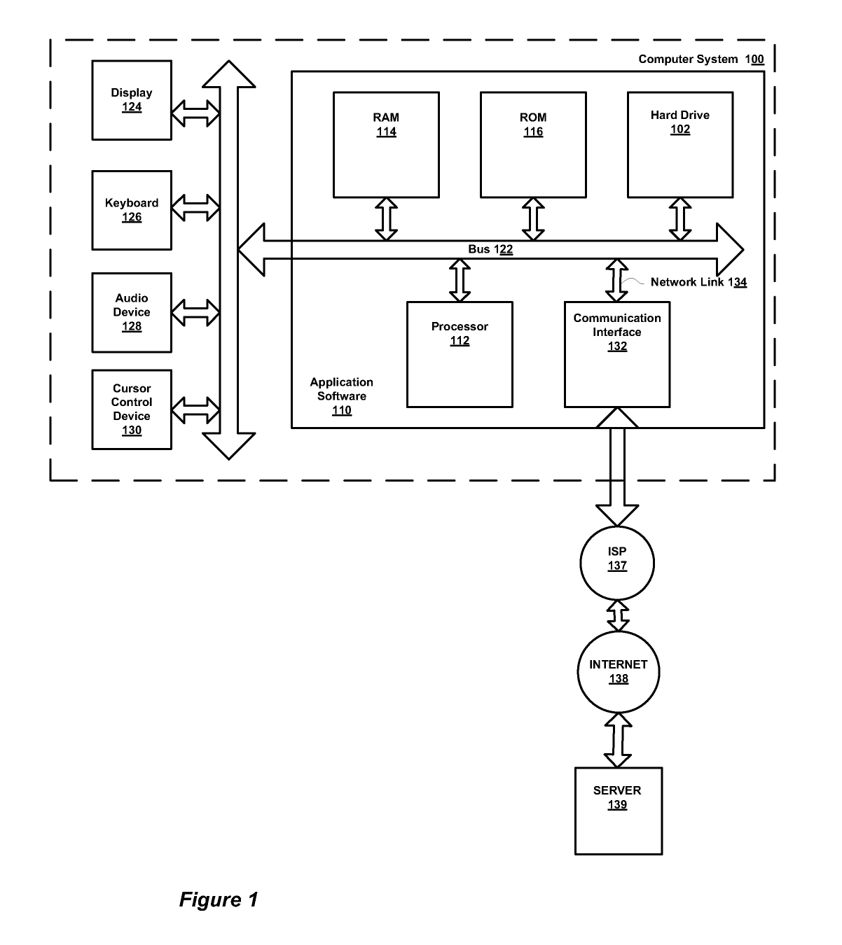

The present invention is a method, apparatus and computer program product for creating and displaying derivative data created from a spreadsheet or table. More specifically, the present invention uses templates to dynamically create and display the derivative data while viewing the originating spreadsheet. A preferred environment for using the present invention is described below in connection with FIG. 1.

Reference now being made to FIG. 1, a block diagram is shown illustrating a computer system 100 that implements a preferred embodiment of the present invention. Computer System 100 includes various components each of which are explained in greater detail below.

Bus 122 represents any type of device capable of providing communication of information within Computer System 100 (e.g., System bus, PCI bus, cross-bar switch, etc.)

Processor 112 can be a general-purpose processor (e.g., the PowerPC™ manufactured by IBM or the Pentium™ manufactured by Intel) that, during normal operation, processes data under the control of an operating system and application software 110 stored in a dynamic storage device such as Random Access Memory (RAM) 114 and a static storage device such as Read Only Memory (ROM) 116. The operating system preferably provides a graphical user interface (GUI) to the user.

The present invention, including the alternative preferred embodiments, can be provided as a computer program product, included on a machine-readable medium having stored on it machine executable instructions used to program computer system 100 to perform a process according to the teachings of the present invention.

The term “machine-readable medium” as used in the specification includes any medium that participates in providing instructions to processor 112 or other components of computer system 100 for execution. Such a medium can take many forms including, but not limited to, non-volatile media, and transmission media. Common forms of non-volatile media include, for example, a floppy disk, a flexible disk, a hard disk, magnetic tape, or any other magnetic medium, a Compact Disk ROM (CD-ROM), a Digital Video Disk-ROM (DVD-ROM) or any other optical medium whether static or rewriteable (e.g., CDRW and DVD RW), punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the preferred embodiment, an example of a non-volatile medium is the Hard Drive 102.

Volatile media includes dynamic memory such as RAM 114. Transmission media includes coaxial cables, copper wire or fiber optics, including the wires that comprise the bus 122. Transmission media can also take the form of acoustic or light waves, such as those generated during radio wave or infrared data communications.

Moreover, the present invention can be downloaded as a computer program product where the program instructions can be transferred from a remote computer such as server 139 to requesting computer system 100 by way of data signals embodied in a carrier wave or other propagation medium via network link 134 (e.g., a modem or network connection) to a communications interface 132 coupled to bus 122.

Communications interface 132 provides a two-way data communications coupling to network link 134 that can be connected, for example, to a Local Area Network (LAN), Wide Area Network (WAN), or as shown, directly to an Internet Service Provider (ISP) 137. In particular, network link 134 may provide wired and/or wireless network communications to one or more networks.

ISP 137 in turn provides data communication services through the Internet 138 or other network. Internet 138 may refer to the worldwide collection of networks and gateways that use a particular protocol, such as Transmission Control Protocol (TCP) and Internet Protocol (IP), to communicate with one another. ISP 137 and Internet 138 both use electrical, electromagnetic, or optical signals that carry digital or analog data streams. The signals through the various networks and the signals on network link 134 and through communication interface 132, which carry the digital or analog data to and from computer system 100, are exemplary forms of carrier waves transporting the information.

In addition, multiple peripheral components can be added to computer system 100. For example, audio device 128 is attached to bus 122 for controlling audio output. A display 124 is also attached to bus 122 for providing visual, tactile or other graphical representation formats. Display 124 can include both non-transparent surfaces, such as monitors, and transparent surfaces, such as headset sunglasses or vehicle windshield displays.

A keyboard 126 and cursor control device 130, such as mouse, trackball, or cursor direction keys, are coupled to bus 122 as interfaces for user inputs to computer system 100.

The application software 110 can be the operating system or a spreadsheet program such as Lotus 1-2-3™ by IBM. The execution of the application software 110 on computer system 100 is explained in greater detail below in connection with the generation of a window that displays the execution of a spreadsheet program.

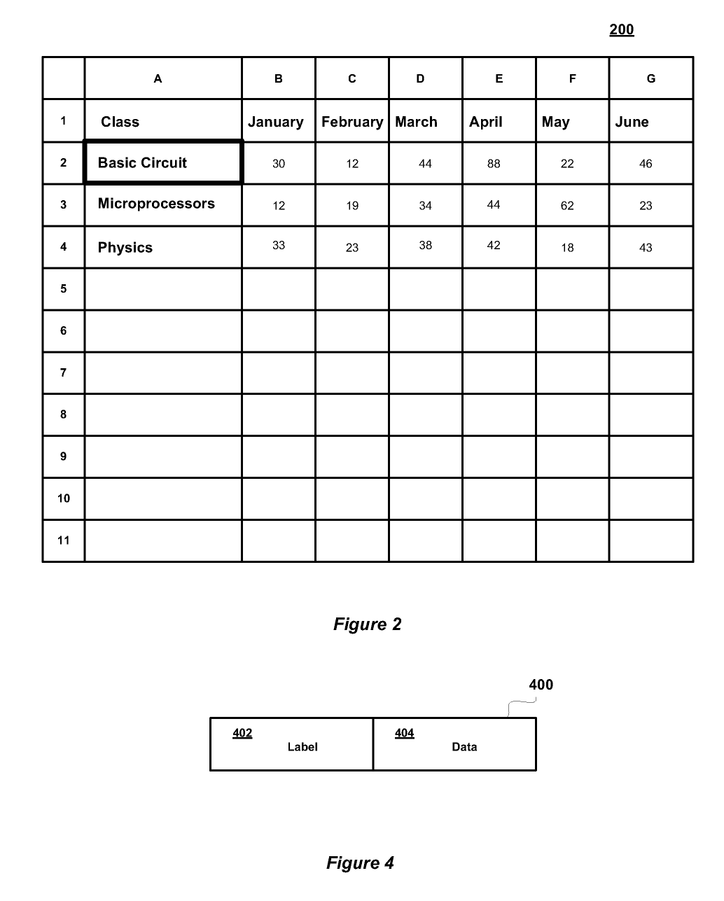

Reference now being made to FIG. 2, a diagram is shown illustrating an example of a spreadsheet application program 200 for attendance data for various classes rendered in a window or other means. In general, spreadsheet 200 is constructed in a fashion that is well known and understood for data display and manipulation using spreadsheet functionality. For example, labels A-G and 1-11 identify columns and rows, respectively. Each cell has an address defined by its corresponding column and row intersection and can contain text, numbers or mathematical formula (e.g., cell B3 contains number 12 and cell B1 contains text “January”).

In this particular example, spreadsheet 200 represents attendance data for Basic Circuit, Microprocessors, and Physics classes for the months of January to June (1^{st} and 2^{nd} quarters). It should be understood, however, that the example of a classroom has been selected for ease of explanation and is not to be considered a limitation on the applicability of the present invention to any type of spreadsheet application regardless of use or complexity.

For the moment, assume, that the spreadsheet 200 is a master spreadsheet that is locked or otherwise protected from unauthorized modification, and reports, graphs or other types of derived data are required. Typically, someone will create a new spreadsheet that contains derivative data such as formula, text, and other relevant information that is dependent upon the data in spreadsheet 200.

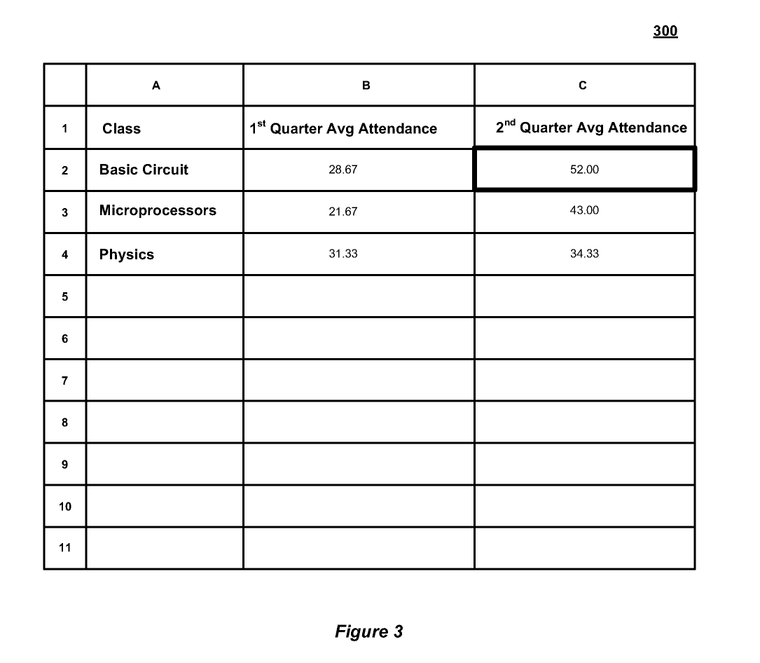

For example, someone who wants to know the average attendance for one or more of the classes (Basic Circuit, Microprocessors, and Physics) for each quarter would be required to create a second spreadsheet to display the desired data such as spreadsheet 300 illustrated in FIG. 3.

In this instance, the average attendance for the classes are illustrated in cells B2-4 and C2-4. Each one of these cells contains a formula that calculates the average attendance for the indicated quarter. For example, cell B2 would contain a formula in a format such as (=Average (Sheet! B2:D2)).

Once spreadsheet 300 has been created and the data generated for each of the cells (B2-4 and C2-4), anyone who desires to see the actual attendance for one or each of the months of the first or second quarters while viewing the average attendance will be required to alternate views between spreadsheet 200 and 300. Alternatively, multiple sheets could be generated according to the preferences of each recipient for labels and/or data. This approach, however, consumes an extremely large amount of valuable time. In addition, as the user creates spreadsheet 300 they are required to alternate their view between the spreadsheets 200 and 300 in order to gather or reference the correct information.

The present invention provides the user with the ability to define one or more templates that display various pieces of information in conjunction with the underlying spreadsheet, thus, alleviating the need to switch or otherwise generate additional spreadsheets as explained below.

Reference now being made to FIG. 4, a block diagram is shown illustrating a template data structure 400 (“template”) according to the teachings of the present invention. The template 400 includes a data field 404 and an optional label field 402. The label field 402 is used for displaying useful information that identifies or otherwise describes information concerning the data represented by data field 404. Data field 404 can be used to display any data including data derived from referenced cells on a spreadsheet.

In the current example, template 400 is used to calculate and display the average student attendance for any quarter as defined by 3 cells (B to D) residing in the same row of spreadsheet 200 where the row is defined as the current row selected by the user (e.g., using the cursor or arrow keys). The location and type of display used to render the template 400 is user definable.

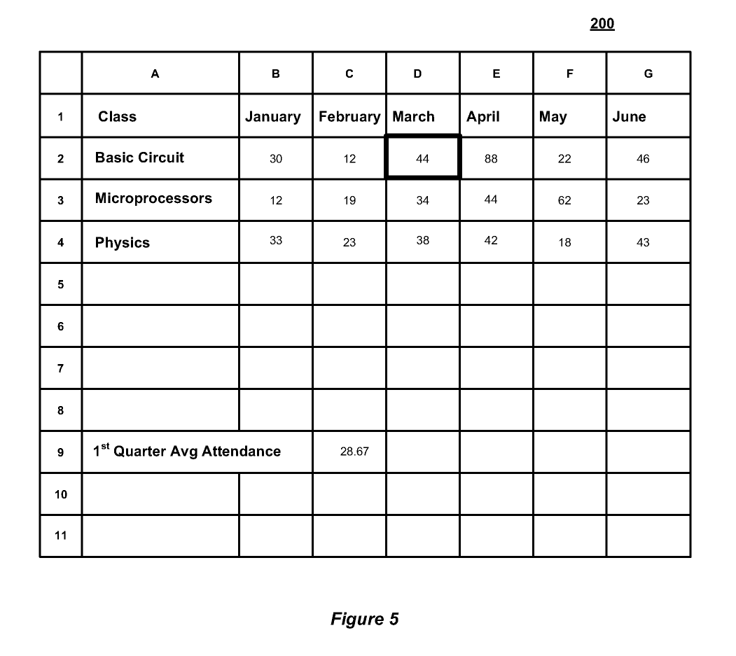

Reference now being made to FIG. 5, the spreadsheet application program 200 of FIG. 2 is shown illustrating an example of the template 400 of FIG. 4 according to the teachings of a preferred embodiment of the present invention. More specifically, the template label “1^{st} Quarter Avg Attendance” 402 and the average for the first quarter of selected row 2 is displayed in the data field 404 in cell A9.

The rendering of the template 400 is user definable and can be accomplished using various well-known and understood techniques. For example, as illustrated, an available cell that is visible and within a predefined distance of the information displayed in the spreadsheet 200 is used to render the template 400. In yet another example, template 400 can be rendered in a separate window that is displayed as the user moves over a referenced cell (i.e., a cell that is referenced in the template). Alternatively, template 400 can be displayed transparently to the left, right, up, or down from the current selected cell location as the user moves over referenced cells.

As illustrated in FIG. 5, the display of the template continues so long as the user selects or moves over one or more cell(s) from which the template data 404 is derived. In this case, cell D2.

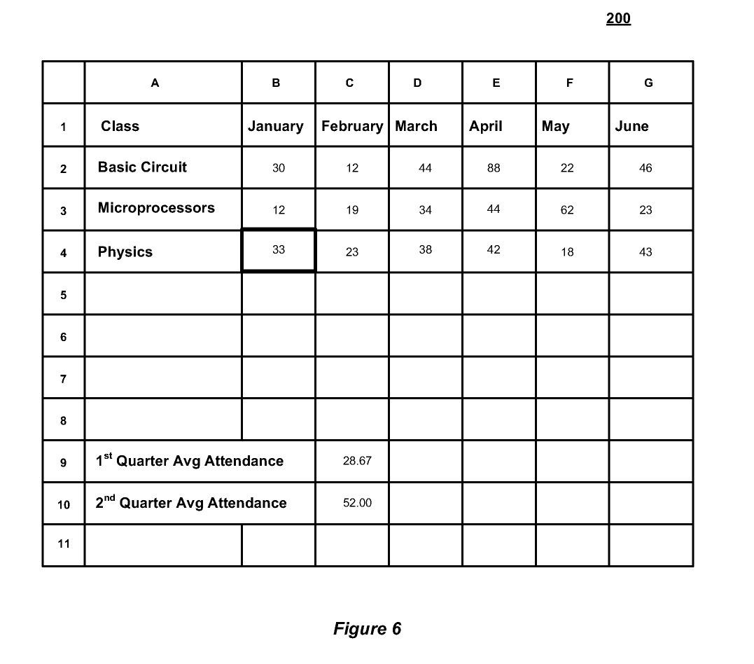

In the preferred embodiment of the present invention, multiple templates can be defined and displayed simultaneously as illustrated in FIG. 6.

In this example, a second template 400 has been defined and displayed with a label 402 of “2^{nd} Quarter Avg Attendance” and data field 404 at cell A10 in a manner as previously described in connection with cell A9. It should be noted that while any cell in row 4 is selected the templates display the data for the selected or indicated row.

In the preferred embodiment of the present invention, formulas for the data field 404 of the template 400 can be defined using the location of other cells relative to the location of a selected cell (e.g., horizontal, vertical, diagonal, spatial, or any combination thereof). For example, a template 400 formula can be represented as a horizontal relationship such as the Average of (cell 1 of a selected row compared to cell 4 of the selected row), or a vertical relationship such as the Average of two cells where cell one is defined as (a selected row−1 selected cell−1) and cell two is defined as (selected row+1 selected cell+1)).

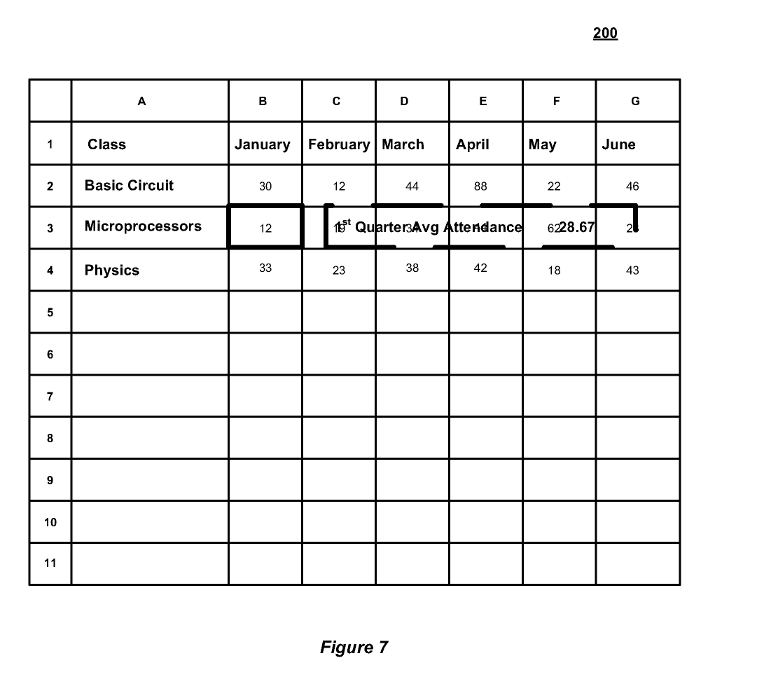

Reference now being made to FIG. 7, the spreadsheet application program 200 of FIG. 2 is shown illustrating an example of the template 400 of FIG. 4 according to the teachings of a preferred embodiment of the present invention. In this example, it can be assumed that the user has defined a new template with the label “1^{st} mo. Quarter Avg” with a formula of (Average (selected row selected cell, selected row selected cell+3)). As shown, the user has selected cell B3 and new template is displayed transparently one cell over. In this case, the data 304 is equal to the average of cell B3 and cell E3 which is 59.

It is thus believed that the operation and construction of the present invention will be apparent from the foregoing description. While the method and system shown and described has been characterized as being preferred, it will be readily apparent that various changes and/or modifications could be made without departing from the spirit and scope of the present invention as defined in the following claims.

What is claimed is:

1. A method of displaying derivative data in a spreadsheet application, the method comprising:
creating a spreadsheet application having multiple cells each capable of storing data;
creating a template that retrieves data from one or more of the multiple cells; and
simultaneously displaying the data from the template and the multiple cells.

2. The method of claim 1 wherein the step of simultaneously displaying includes:
displaying the template in one of the cells that is currently not being used for storing data and is viewable by the user.

3. The method of claim 1 wherein the step of simultaneously displaying includes:
displaying the template transparently over one or more of the cells.

4. The method of claim 1 wherein the step of creating a template includes:
creating a template that generates a derivative data value based upon the value of the data stored in one or more cells residing in one or more rows.

5. The method of claim 4 wherein the step of creating a template that generates a derivative data value includes:
creating a template that generates a derivative data value based upon the value of the data stored in one or more cells of a selected row.

6. The method of claim 4 wherein the step of creating a template that generates a derivative data value includes:
creating a template that generates a derivative data value based upon the value of the data stored in one or more cells of a row based upon the location of a selected row and cell.

7. The method of claim 6 wherein the step of simultaneously displaying includes:
displaying the template transparently over one or more of the cells.

8. An apparatus for displaying derivative data in a spreadsheet application, the apparatus comprising:
means for creating a spreadsheet application having multiple cells each capable of storing data;
means for creating a template that retrieves data from one or more of the multiple cells; and
means for simultaneously displaying the template and the multiple cells.

9. The apparatus of claim 8 wherein the means for simultaneously displaying includes:
means for displaying the template in one of the cells that is currently not being used for storing data and is viewable by the user.

10. The apparatus of claim 8 wherein the means for simultaneously displaying includes:
means for displaying the template transparently over one or more of the cells.

11. The apparatus of claim 8 wherein the means for creating a template includes:
means for creating a template that generates a derivative data value based upon the value of the data stored in one or more cells residing in one or more rows.

12. The apparatus of claim 11 wherein the means for creating a template that generates a derivative data value includes:
means for creating a template that generates a derivative data value based upon the value of the data stored in one or more cells of a selected row.

13. The apparatus of claim 11 wherein the means for creating a template that generates a derivative data value includes:
means for creating a template that generates a derivative data value based upon the value of the data stored in one or more cells of a row based upon the location of a selected row and cell.

14. The apparatus of claim 13 wherein the means for simultaneously displaying includes:
means for displaying the template transparently over one or more of the cells.

15. A computer program product comprising a computer usable medium having computer usable program code for displaying derivative data in a spreadsheet application, the computer usable program code comprising:
computer usable program code for creating a spreadsheet application having multiple cells each capable of storing data;
computer usable program code for creating a template that retrieves data from one or more of the multiple cells; and
computer usable program code for simultaneously displaying the template and the multiple cells.

16. The computer program product of claim 15 wherein the computer usable program code for simultaneously displaying includes:
computer usable program code for displaying the template in one of the cells that is currently not being used for storing data and is viewable by the user.

17. The computer program product of claim 15 wherein the computer usable program code for simultaneously displaying includes:
computer usable program code for displaying the template transparently over one or more of the cells.

18. The computer program product of claim 15 wherein the computer usable program code for creating a template includes:
computer usable program code for creating a template that generates a derivative data value based upon the value of the data stored in one or more cells residing in one or more rows.

19. The computer program product of claim 18 wherein the computer usable program code for creating a template that generates a derivative data value includes:
computer usable program code for creating a template that generates a derivative data value based upon the value of the data stored in one or more cells of a selected row.

20. The computer program of claim 18 wherein the computer usable program code for creating a template that generates a derivative data value includes:
computer usable program code for creating a template that generates a derivative data value based upon the value of the data stored in one or more cells of a row based upon the location of a selected row and cell.
